(19) United States
(12) Patent Application Publication
(10) Pub. No.: US 2020/0294293 A1
(43) Pub. Date: Sep. 17, 2020

(54) PERSISTENT AUGMENTED REALITY OBJECTS

(71) Applicant: INTERNATIONAL BUSINESS MACHINES CORPORATION, Armonk, NY (US)

(72) Inventors: Ronald David Boenig, II, Denver, CO (US); David C. Reed, Tucson, AZ (US); Michael R. Scott, Ocean View, HI (US); Samuel Smith, Vail, AZ (US)

(21) Appl. No.: 16/351,869

(22) Filed: Mar. 13, 2019

(51) Int. Cl. G06T 11/60; G06K 9/00; G06T 7/246; G06F 21/10

(52) U.S. Cl. CPC G06T 11/60; G06K 9/00718; G06F 2221/0713; G06F 21/10; G06T 2207/10016; G06T 7/246

(57) ABSTRACT

Methods, systems and computer program products for providing persistent augmented reality objects are provided. Aspects include storing user credentials by an augmented reality device. Aspects also include detecting an object identification tag disposed on a physical object. Aspects also include retrieving virtual content associated with the physical object from an online registry based on the user credentials and the object identification tag. Aspects also include displaying the virtual content in association with the physical object by the augmented reality device.

### BACKGROUND

The present invention generally relates to augmented reality systems, and more specifically, to providing persistent augmented reality objects.

Augmented reality systems allow for a live view of a physical, real-world environment that is augmented by computer-generated virtual content such as sound, images, videos or other data that can be superimposed over a view of the real-world using an augmented reality display. Augmented reality headsets are wearable devices that allow a user to view virtual content while moving freely about the world. Conventional augmented reality systems generally utilize location data (e.g., GPS data) of the device to determine which content to load, which can present problems if the physical objects that are intended to be associated with the virtual content have been moved to another location.

### SUMMARY

Embodiments of the present invention are directed to a computer-implemented method for providing persistent augmented reality objects. A non-limiting example of the computer-implemented method includes storing user credentials by an augmented reality device. The method also includes detecting an object identification tag disposed on a physical object. The method also includes retrieving virtual content associated with the physical object from an online registry based on the user credentials and the object identification tag. The method also includes displaying the virtual content in association with the physical object by the augmented reality device.

Embodiments of the present invention are directed to a system for providing persistent augmented reality objects. The system includes an augmented reality device that has a memory for storing computer readable computer instructions and a processor for executing the computer readable instructions. The computer readable instructions include instructions for storing user credentials. The computer readable instructions also include instructions for detecting an object identification tag disposed on a physical object. The computer readable instructions also include instructions for retrieving virtual content associated with the physical object from an online registry based on the user credentials and the object identification tag. The computer readable instructions also include instructions for displaying the virtual content in association with the physical object by an augmented reality display of the augmented reality device.

Embodiments of the invention are directed to a computer program product for providing persistent augmented reality objects, the computer program product comprising a computer readable storage medium having program instructions embodied therewith. The computer readable storage medium is not a transitory signal per se. The program instructions are executable by a processor to cause the processor to perform a method. A non-limiting example of the method includes storing user credentials by an augmented reality device. The method also includes detecting an object identification tag disposed on a physical object. The method also includes retrieving virtual content associated with the physical object from an online registry based on the user credentials and the object identification tag. The method also includes displaying the virtual content in association with the physical object by the augmented reality device.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a cloud computing environment according to one or more embodiments of the present invention;

FIG. 2 depicts abstraction model layers according to one or more embodiments of the present invention;

FIG. 3 depicts a block diagram of a computer system for use in implementing one or more embodiments of the present invention;

FIG. 4 depicts a system upon which providing persistent augmented reality objects may be implemented according to one or more embodiments of the present invention;

FIG. 5 depicts a block diagram of a blockchain for use in implementing one or more embodiments of the present invention; and

FIG. 6 depicts a flow diagram of a method for providing persistent augmented reality objects according to one or more embodiments of the invention.

The diagrams depicted herein are illustrative. There can be many variations to the diagrams or the operations described therein without departing from the spirit of the invention. For instance, the actions can be performed in a differing order or actions can be added, deleted or modified. Also, the term “coupled” and variations thereof describe having a communications path between two elements and do not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

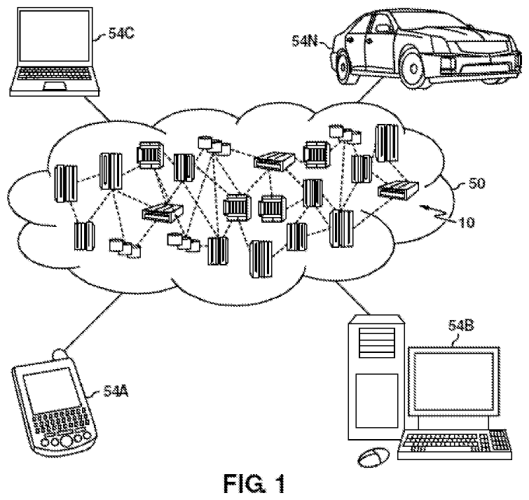

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

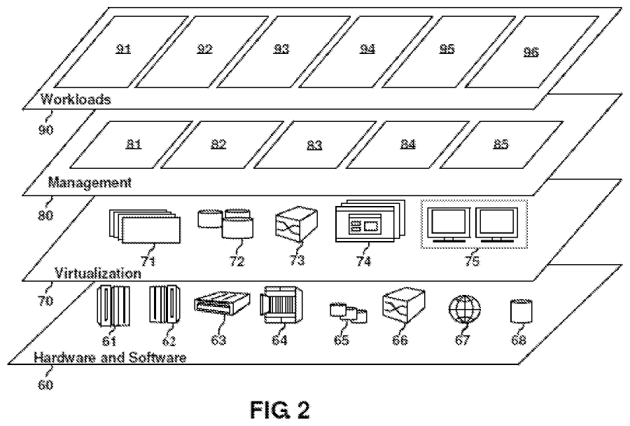

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and providing persistent augmented reality objects 96.

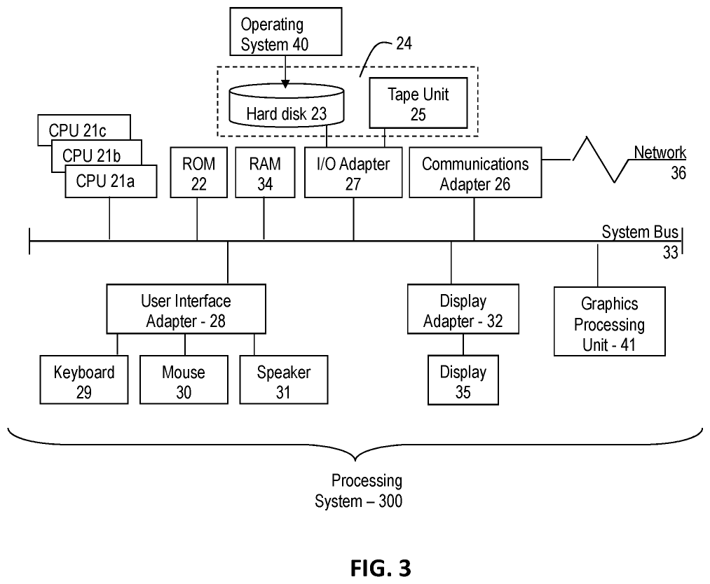

Referring to FIG. 3, there is shown an embodiment of a processing system 300 for implementing the teachings herein. In this embodiment, the system 300 has one or more central processing units (processors) 21a, 21b, 21c, etc. (collectively or generically referred to as processor(s) 21). In one or more embodiments, each processor 21 may include a reduced instruction set computer (RISC) microprocessor. Processors 21 are coupled to system memory 34 and various other components via a system bus 33. Read only memory (ROM) 22 is coupled to the system bus 33 and may include a basic input/output system (BIOS), which controls certain basic functions of system 300.

FIG. 3 further depicts an input/output (I/O) adapter 27 and a network adapter 26 coupled to the system bus 33. I/O adapter 27 may be a small computer system interface (SCSI) adapter that communicates with a hard disk 23 and/or tape storage drive 25 or any other similar component. I/O adapter 27, hard disk 23, and tape storage device 25 are collectively referred to herein as mass storage 24. Operating system 40 for execution on the processing system 300 may be stored in mass storage 24. A network adapter 26 interconnects bus 33 with an outside network 36 enabling data processing system 300 to communicate with other such systems. A screen (e.g., a display monitor) 35 is connected to system bus 33 by display adaptor 32, which may include a graphics adapter to improve the performance of graphics intensive applications and a video controller. In one embodiment, adapters 27, 26, and 32 may be connected to one or more I/O busses that are connected to system bus 33 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 33 via user interface adapter 28 and display adapter 32. A keyboard 29, mouse 30, and speaker 31 all interconnected to bus 33 via user interface adapter 28, which may include, for example, a Super I/O chip integrating multiple device adapters into a single integrated circuit.

In exemplary embodiments, the processing system 300 includes a graphics processing unit 41. Graphics processing unit 41 is a specialized electronic circuit designed to manipulate and alter memory to accelerate the creation of images in a frame buffer intended for output to a display. In general, graphics processing unit 41 is very efficient at manipulating computer graphics and image processing and has a highly parallel structure that makes it more effective than general-purpose CPUs for algorithms where processing of large blocks of data is done in parallel.

Thus, as configured in FIG. 3, the system 300 includes processing capability in the form of processors 21, storage capability including system memory 34 and mass storage 24, input means such as keyboard 29 and mouse 30, and output capability including speaker 31 and display 35. In one embodiment, a portion of system memory 34 and mass storage 24 collectively store an operating system coordinate the functions of the various components shown in FIG. 3.

In exemplary embodiments, a system for providing persistent augmented reality objects is provided. The system may display virtual content via an augmented reality display of an augmented reality device to create an augmented reality view of the physical world from the perspective of a wearer of the augmented reality device. A persistent augmented reality object may refer to virtual content that is displayed persistently in association with a physical object that is within view of an augmented reality device, such as an augmented reality device that is worn or otherwise used by a user. The virtual content may be displayed based upon the detection of an AR tagged object and may be persistently displayed for as long as the AR tagged object remains within the field of view of the user of the augmented reality device, regardless of any movement by the AR tagged object or user.

In exemplary embodiments, an augmented reality device can be configured to detect object identification tags that are disposed on physical objects (i.e., AR tagged objects) as a user moves about the world. Such object identification tags provide an indication that the associated object may have associated virtual content that can be retrieved and displayed by the augmented reality device. Thus, according to some embodiments, the augmented reality device may retrieve virtual content from an online registry of virtual content by providing the identification tag and user credentials associated with the user of the augmented reality device to the online registry. In response, the online registry may allow the augmented reality device to download or otherwise access virtual content that can be displayed by the augmented reality device in association with the physical object. For example, a necklace that has an object identification tag may be detected by an augmented reality device, which then may retrieve an image of an employee badge associated with the necklace. The augmented reality device may then superimpose the retrieved image of the employee badge over the necklace in the field of view of the wearer of the augmented reality device. The system may track the object as it moves, such that for example, as the wearer of the necklace walks across the room in the physical world, the superimposed display of the retrieved image will move along with the user. The system may allow an owner of virtual content to create different access levels for different virtual content, such that, some virtual content may be available to the general public whereas other content may be restricted to individuals whose user credentials include the appropriate security credentials. For example, in the case of the necklace, all users may be able to view the necklace wearer's employee badge via the system, but a subset of users (e.g., managers or executives) may also be presented with additional information such as the necklace wearer's job title, position, work schedule, and the like. Thus, the disclosed system may provide for access control to different tiers of virtual content as may be specified by the virtual content creators.

According to some embodiments, the online registry may be stored on a server that may allow upload and download of virtual content by users that are authorized to access the server. In some embodiments, the online registry may be a public distributed ledger that may be accessible by the general public. Using a distributed ledger as the online registry provides the advantage that anyone can freely add virtual content to the registry in association with any physical object as long as the object identification tag is known, thereby providing a technical advantage of allowing for the sharing of virtual content without requiring the use of a proprietary system. Uploaders of content can specify one or more authorization levels or security clearances that are needed to access the virtual content, such that only those end users who have the appropriate security credentials may access the respective virtual content. Accordingly, embodiments of the disclosure can provide technical advantages by providing both access control to some or all virtual content and the ability to display virtual content with respect to objects without regard to the location of the object. Thus, embodiments of the disclosed invention may be particularly useful to allow users to view virtual content via an augmented reality device with respect to physical objects that are subject to movement (e.g., a vehicle, a moveable piece of equipment, an item carried by an individual, etc.) and about which it may be desirable to have different amounts of information based on a user's authorization level.

According to some embodiments, embodiments of the present disclosure may include a proprietary protocol that may operate as an intermediary server between virtual content providers and clients. Such protocol services may include for example, providing secure registries for content providers to register companies and entities as certified providers of augmented reality media and stimuli, securing storage on behalf of content providers and augmented reality media and stimuli files and/or a table of Internet hyperlinks routing to media stored by content providers, providing downloadable and Internet-accessible file conversion tools that may be used to convert data and media files to the proper format to meet the proprietary protocol specifications, providing a content rating system that can define and demarcate the properties of augmented reality media and stimuli files as well as provide for access control of these content files, and providing a customizable web API to provide data feedback to content providers such as data indicating usage, security and access violations, and the like. A content rating system can allow a user (e.g., a content creator) to specify a variety of content based on attributes of the identity of a user that is accessing the content. For example, certain content may be age restricted, such that a person accessing the content must be of a certain age to view the content, or else the user may be restricted from viewing the content and instead may be presented with alternative content that is age appropriate. According to some embodiments, protocol services made available to clients (i.e., users of augmented reality devices), may include providing a secure registry for clients to register individuals and group organizations, defining security protocols, detailing formatting characteristics of the data, retrieval of proprietary protocol-formatted augmented reality stimuli and media files to be viewed, heard, or otherwise decoded and represented by client augmented reality interface technology (e.g., augmented reality devices), and controlling and filtering of virtual content created by content providers and delivered by the system, using the content rating system properties to define a unique filtration of content per individual content user.

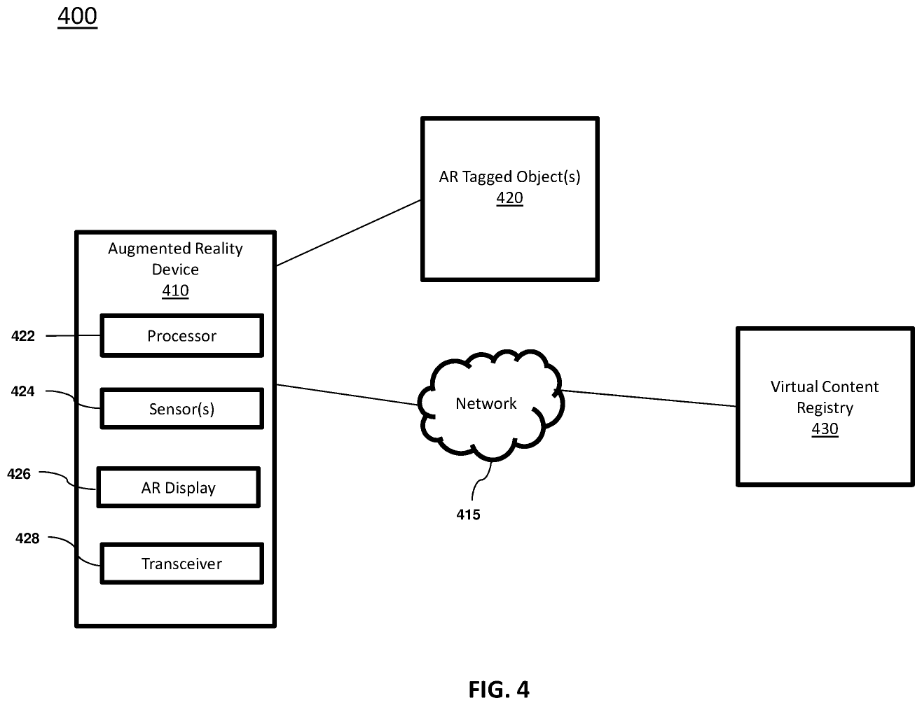

Turning now to FIG. 4, a system 400 for providing persistent augmented reality objects will now be described in accordance with an embodiment. The system 400 includes an augmented reality device 410 in communication with a virtual content registry via communications network 415. As will be described herein, augmented reality device 410 is configured to view and/or detect AR tagged objects 420 in the vicinity of augmented reality device 410. AR tagged objects 420 may be physical objects that each include an object identification tag that is detectable by augmented reality device 410. The communications network 415 may be one or more of, or a combination of, public (e.g., Internet), private (e.g., local area network, wide area network, virtual private network), and may include wireless and wireline transmission systems (e.g., satellite, cellular network, terrestrial networks, etc.

In exemplary embodiments, augmented reality device 410 can include, but is not limited to, an augmented reality headset, a virtual reality headset, a smartphone, a wearable device, a tablet, a computer system such as the one shown in FIG. 3, or any other suitable electronic device. The augmented reality device 410 includes a processor 422, one or more sensors 424, an augmented reality (AR) display 426 and a transceiver 428. The sensors 424 can include one or more of an image capture device (e.g., digital camera) for obtaining images and/or videos, a microphone for obtaining audio recordings, and a location sensor for obtaining location data of the user device (e.g., GPS coordinates). In some embodiments, AR display 426 is configured to superimpose display virtual content, such as images and/or video, over a view of a real-world scene. Accordingly, in some embodiments, an AR display 426 may be a video screen that includes superimposed virtual content over physical objects. In some embodiment, an AR display 426 may include a transparent display that is capable of displaying superimposed virtual content over a user's view of the real world, such as a heads-up display. As will be appreciated by those of skill in the art, an augmented reality device 410 may include a video camera that may continuously obtain video footage of the user's viewpoint and this video footage may be used in real-time or near real-time to determine where to display (or superimpose) the virtual content based on the direction the user is looking and/or the positions of objects within the user's field of view. Transceiver 428 can be configured to allow an augmented reality device 410 to communicate with other devices via communications network 415 (e.g., via Wi-Fi, cellular communications, etc.).

Each AR tagged object 420 is a physical object that includes an object identification tag. According to some embodiments, an object identification tag may be one or more of, but not limited to, a barcode, a QR code, a radio frequency tag, a wireless communication signal, BLUETOOTH™, near-field communication (NFC) or any other suitable form of detectable tag. Accordingly, in some embodiments, augmented reality device 410 can be configured to detect an object identification tag disposed on an AR tagged object 420 by obtaining one or more images of the AR tagged object and performing image recognition on the images to identify a barcode, a QR code or any other visual indicia that may be used as a tag. In some embodiments, augmented reality device 410 can be configured to detect radio frequency signals or other types of wireless signals transmitted by a radio frequency tag or other wireless tags in order to detect the object identification tag. According to some embodiments, after detecting an object identification tag, augmented reality device 410 may store one or more images of the AR tagged object 420 that is associated with the detected tag to use in visually tracking movement of the AR tagged object 420. In some embodiments, the augmented reality device 410 may be configured to visually track the movement of one or more identified AR tagged objects 420 as the object(s) moves, such that the position of such AR tagged objects 420 within the field of view of the augmented reality device 410 (e.g., within view of a camera or other such visual sensor of augmented reality device 410) may be known by the augmented reality device 410. As will be appreciated by those of skill in the art, various motion detection and tracking software exists that may be utilized by augmented reality device 410 to perform such motion tracking of objects. Similarly, as will be appreciated by those of skill in the art, various object/image recognition software may be utilized by augmented reality device 410 to aid in motion tracking or re-identifying a previously identified AR tagged object 420. For example, if an object leaves and re-enters the field of view of the augmented reality device 410, the augmented reality device 410 may apply image recognition techniques using the previously stored images to determine that the object is a particular previously identified AR tagged object 420. In some embodiments, the augmented reality device 410 may include a sensor 424 that is a radio frequency identification (RFID) reader that can allow the augmented reality device to read an RFID tag associated with an AR tagged object 420 to identify the object. According to some embodiments, if the augmented reality device 410 detects a wireless or radio frequency tag associated with the AR tagged object 420 such that it is not immediately clear which object within the user's field of view is associated with the tag, the augmented reality device 410 may determine the identity of the AR tagged object 420 by, for example, correlating changes in the detected signal strength of the wireless or radio frequency tag with movements made by the augmented reality device 410 or by downloading stored object image from the virtual content registry 430 based on the object identification tag to aid in image recognition of the object.

According to some embodiments, augmented reality device 410 can be configured to store user credentials associated with a user of the augmented reality device 410. For example, in some embodiments, a user may be required to log in to an augmented reality device 410 by for example inputting a username and password or providing a biometric authentication (e.g., facial recognition in a mirror, retinal scan, fingerprint scan, etc.). According to some embodiments, a user of augmented reality device 410 may have one or more security credentials that can be stored in association with the user credentials on the augmented reality device 410. The augmented reality device 410 can be configured to transmit the user credentials and optionally security credentials to virtual content registry along with one or more detected object identification tags in order to retrieve authorized virtual content from the virtual content registry 430.

In some embodiments, a virtual content registry 430 can be a database stored on a server. In some embodiments, virtual content registry 430 can be embodied in a distributed ledger (e.g., using blockchain technology). As will be understood by those of skill in the art, a distributed ledger may be a ledger of transactions and/or data that is stored in multiple copies across multiple devices. Whether embodied in a central server, a distributed ledger or some other form, in some embodiments, the virtual content registry may be configured to process user credentials and/or associated security credentials in addition to the object identification tag to determine which, if any, virtual content stored in associated with the object identification tag that the user is authorized to view. According to some embodiments, virtual content registry 430 may store data representative of the virtual content itself. In some embodiments, virtual content registry 430 may store one or more links to third party websites or servers that store and/or provide access to the virtual content. Virtual content may include image(s), video(s), text, audio file(s), or interactive content that can be presented when viewing the associated real-world physical object that is associated with the respective object identification tag using the augmented reality device 410. For example, in some embodiments, when viewing an object associated with a detected object identification tag, augmented reality device may display an image or play an audio file that is associated with the object identification tag and is accessed from the virtual content registry. According to some embodiments, the virtual content may include a link to a third party server that may allow augmented reality device 410 to establish a remote connection with the third party server to display interactive content hosted by the third party server. For example, a user of augmented reality device 410 may be viewing a server rack in the physical world, and upon detecting an object identification tag associated with the server rack, the augmented reality device 410 may access a link stored by the virtual content registry 430 that connects the augmented reality device 410 to a third party server run by the company that operates the servers in the server rack. The third-party server may provide the augmented reality device 410 with virtual interactive content, such as a virtual control panel, and in response to detecting user interactions with the virtual control panel, the augmented reality device 410 may communicate commands to the third party server that may cause real-world actions to occur. For example, the virtual control panel may include a server reset button associated with each server on the rack, and in response to detecting that the user has selected a given server reset button (e.g., by touching their finger to the virtual image of the button within view of the camera of the augmented reality device 410), the augmented reality device 410 may cause the third party server to issue a remote command to the associated server in the server rack to perform a reset function. Thus, in combination with the access control functionality described herein, embodiments of the present disclosure can allow users of various security clearance levels to have access to executing one or more real-world remote functionalities in relation to an object and based on the particular user's authorization level. Thus, users with a low authorization level may be allowed to access and execute basic functionalities, whereas users with a high authorization level may have access to many more remote functionalities associated with an object.

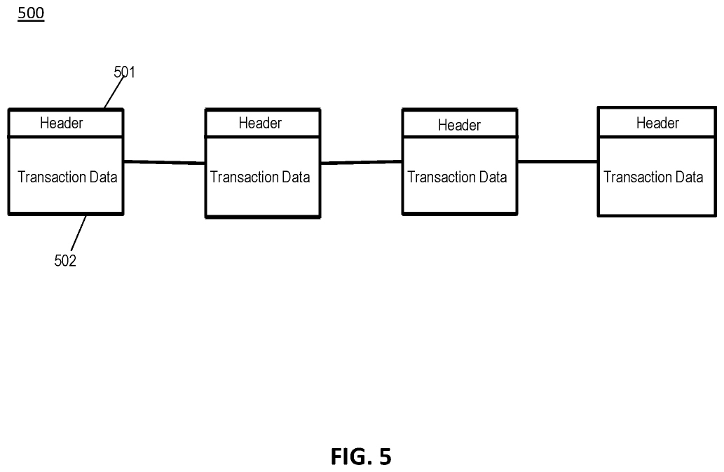

FIG. 5 depicts a diagram of an exemplary blockchain 500, which, in some embodiments, can store the virtual content registry 430. A blockchain 500 is computer-based distributed ledger comprised of individual blocks connected in a chain. Each block is comprised of a block header 501 and transactional data 502. In general, a block header 501 contains metadata describing the version of the blockchain, a cryptographic hash of the previous block, a root hash describing each transaction contained in the block, a timestamp, a difficulty setting for mining the block, and a nonce value. The block hash value is derived from an encryption algorithm that converts a series of input numbers and letters into an encrypted output having a fixed length.

Each successive block comprises a hash pointer as a link to a previous block, thereby creating the chain. Due to the difficulty of mining a block, the integrity of the data contained in each block is resistant to bad actors attempting to modify or delete data. For this reason, a blockchain is a suitable system for recording transactions or otherwise maintaining the integrity of the stored data.

Embodiments of the present invention may employ blockchain code to allow users to store virtual content that is associated with a physical object by uploading the virtual content in association with the object identification tag to the blockchain. An augmented reality device 410 may include an API or other software that allows it to locate data stored in the blockchain that is associated with a detected object identification tag, and download or otherwise access the virtual content for display by the augmented reality device 410 in association with the object. According to some embodiments, the blockchain may store the virtual content itself for download by the augmented reality device 410, or alternatively may store, for example, a link to a third party server or website that hosts the virtual content, which may be accessed by the augmented reality device upon utilizing the link. As described previously, a virtual content owner may also place access control restrictions on the virtual content to control which users can access which portions of virtual content. In the blockchain context, in some embodiments, this security may be enabled by utilizing built-in blockchain capabilities to secure the blockchain ledger. For example, each transaction in the chain may be secured so that only authorized individuals can access the transaction record. The record can be set to allow public access, which may be the default setting for all non-authorized users. The record can also be set to only allow access to authorized users or groups. In this case, the wearer of an augmented reality device 410 would have to be registered with an appropriate access level by the owner or creator of the virtual content. In some embodiments, access control restrictions may be created in the blockchain context by utilizing tools that use blockchain to create permanent digital identifications, such as IBM's Blockchain Trusted Identity™ or a similar solution to identify the wearer of an augmented reality device 410 and verify what objects or virtual content they are allowed to access.

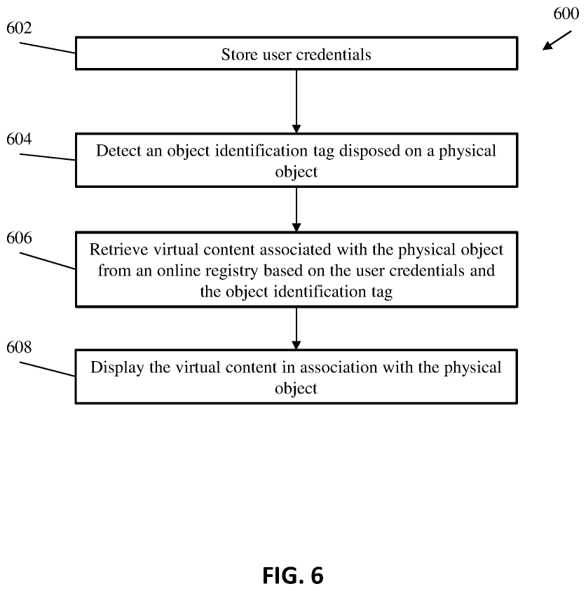

Turning now to FIG. 6, a flow diagram of a method 600 for providing persistent augmented reality objects in accordance with an embodiment is shown. In one or more embodiments of the present invention, the method 600 may be embodied in software that is executed by an augmented reality device 410. According to some embodiments, some aspects of the method may be executed by computer elements located within a network that may reside in the cloud, such as the cloud computing environment 50 described herein above and illustrated in FIGS. 1 and 2. In other embodiments, the computer elements may reside on a computer system or processing system, such as the processing system 300 described herein above and illustrated in FIG. 3, or in some other type of computing or processing environment.

The method 600 begins at block 602 and includes storing (e.g., via augmented reality device 410) user credentials by, for example, an augmented reality device 410. User credentials may be, for example, a username, password or identification number. In some embodiments, user credentials may include biometric signals of a user that can be verified during use of the augmented reality device 410, such as for example, fingerprints, retina scan, facial recognition, voice recognition, or any other such suitable biometric signal that can be used for user authentication. User credentials may also include a code or identification provided by a third party. For example, a virtual content creator who initially uploads virtual content to a virtual content registry 430 may assign one or more passcodes to the virtual content for accessing parts of the virtual content, therefore, the creator may distribute the passcodes to trusted users such that when a trusted user accesses the virtual content registry using the stored passcode, the augmented reality device 410 will be granted access to view the appropriate virtual content. According to some embodiments, such passcodes may be time-sensitive, such that a given passcode no longer provides access to virtual content beyond a predetermined day and/or time that is specified by the creator.

As shown at block 604, the method includes detecting (e.g., via augmented reality device 410) an object identification tag disposed on a physical object. According to some embodiments, the object identification tag disposed on the physical object can be one of a barcode, a QR code, a radio frequency tag, or a wireless communication signal. Accordingly, in various embodiments, detecting the object identification tag can include performing image recognition or scanning of images of the object obtained by the augmented reality device 410 to visually detect and decode a barcode, QR code, or any other such visual indication of an object identification tag. In some embodiments, detecting the object identification tag can include detecting a code embodied in radio frequency or another wireless signal (e.g., BLUETOOTH™, NFC, etc.) that is emitted by a radio frequency (or other wireless) tag associated with a physical object using, for example, an RFID reader associated with the augmented reality device 410. It should be understood that the example provided herein are merely illustrative and that any known method of identifying an AR tagged object 420 may be utilized by an augmented reality device 410 according to various embodiments.

As shown at block 606, the method includes retrieving (e.g., via augmented reality device 410) virtual content associated with the physical object from an online registry 430 based on the user credentials and the object identification tag. The virtual content can include one or more of an image, a video, an audio file or an interactive display. According to some embodiments, retrieving the virtual content from the online registry 430 can include identifying a record in the registry 430 that corresponds to the object identification tag and retrieving virtual content associated with the record in the registry 430. In some embodiments, the virtual content registry 430 may include a link to a third party server or website that when activated, may provide a secure connection between augmented reality device 410 and the third party server to allow augmented reality device to 410 to download or otherwise access the virtual content. In some embodiments, prior to retrieval of the virtual content from the online registry 430, the method may include adding the virtual content to the online registry 430 by a virtual content creator that is unaffiliated with a user of the augmented reality device. As described above, in some embodiments, the virtual content registry 430 may be implemented using a public distributed ledger, and as such it may not be necessary for the creator of the content to have any affiliation with the person accessing the content.

According to some embodiments, the online registry 430 may include virtual content that is associated with different security clearances. For example, some virtual content may be publicly accessible, whereas other virtual content may require appropriate security credentials to access. Accordingly, in some embodiments, retrieving the virtual content can include retrieving a first virtual content element that is accessible to all users and retrieving a second virtual content element that is accessible to authorized users, wherein the user credentials can include security credentials that provide access to the second virtual content element. Thus, in some embodiments, different users having different security clearances or authorization levels may be granted access to different virtual content for display by an augmented reality device 410 with respect to the same object, based on their respective authorization level. Furthermore, for virtual content that includes an interactive element, such as an interactive display that executes real-world functionality in response to interaction with the interactive display, users may be provided with access to different functionalities based on their associated authorization levels as reflected by their security credentials.

As shown at block 608, the method includes displaying the virtual content in association with the physical object by the augmented reality device 410. According to some embodiments, displaying the virtual content in association with the physical object can include superimposing the virtual content over the physical object in an augmented reality display of the augmented reality device. In some embodiments, the nature of the virtual content displayed can depend on the associated authorization level held by the user of the augmented reality device, as reflected by the security credentials of the user stored by the augmented reality device 410. According to some embodiments, the virtual content associated with the object identification tag may be displayed by the augmented reality device 410 in association with the physical object in a persistent manner such that the virtual content will be displayed as long as the object is within the field of view of a camera of the augmented reality device 410. According to some embodiments, the display of the virtual content may be sized in proportion to the visible size of the object. For example, if virtual content that is associated with a ball that is viewable by the augmented reality device 410 comprises an image, and augmented reality device 410 superimposes the image over the ball within the field of view of a user of the augmented reality device 410, in some embodiments, as the user moves towards the ball, the display of the image may enlarge along with the enlarging view of the ball in reality, and likewise the size of the image may decrease if the user moves away from the ball. According to some embodiments, the virtual content registry 430 may store instructions associated with virtual content that may instruct augmented reality device 410 regarding how to display the virtual content in augmented reality. For example, the instructions may provide details regarding the format of the presentation of virtual content, such as a volume level for audio content, whether the virtual content is static or changes in some way, and/or a size or shape of the virtual content to be displayed, which may be a function of the viewable size of the object (i.e., based on the location of the user relative to the object). The instructions may provide an indication of whether the virtual content should be superimposed over all or a portion of the view of the object in the augmented reality display 426 of the augmented reality device 410. In some embodiments, the instructions may provide an indication that the virtual content should be displayed in augmented reality in a manner that does not obstruct a view of the associated object. For example, an augmented reality device 410 may display an interactive virtual control board in association with a view of a machine, but it may be desirable to view the operation of the machine when activating one or more interactive controls, and so the instructions may instruct the augmented reality device 410 to display the interactive virtual control board adjacent to the machine in the view of the augmented reality display 426. According to some embodiments, the instructions may provide parameters set by the virtual content creator or owner of an AR tagged object 420 that may affect the presentation or access to virtual content. According to some embodiments, the instructions may change the format or presentation of virtual content based on the location of the AR tagged object 420 and/or the augmented reality device 410. For example, the instructions may cause the augmented reality device 410 to present static (i.e., non-changing) virtual content in association with an AR tagged object 420 if the location of the AR tagged object 420 is within a predefined area, but may cause the augmented reality device 410 to present animated or dynamic virtual content in association with the AR tagged object 420 if the object is determined to be outside the predetermined area. According to some embodiments, the location of the AR tagged object 420 may be determined by the augmented reality device 410 by, for example, receiving a location signal (e.g., global positioning system (GPS) signal) from an electronic tag associated with the AR tagged object 420, or for example, utilizing known visual image and/or wireless signal-based distance measurement techniques in combination with a GPS location of the augmented reality device 410. According to some embodiments, instructions associated with virtual content may include rules for responding to user inputs (e.g., selection of a virtual button) from a wearer of an augmented reality device 410 that is interacting with virtual content associated with an AR tagged object 420. For example, the instructions may cause the augmented reality device 410 to change the audio and/or visual virtual content displayed by the augmented reality device 410 or may initiate virtual or real world software processes in response to the user input.

According to some embodiments, the method can further include tracking, by the augmented reality device, movement of the physical object and superimposing the virtual content over the physical object such that the virtual content moves to track the movement of the physical object. For example, a juggler may be juggling three balls, and each ball may have an object identification tag and be associated with different virtual content, such as a different virtual image. After detecting the respective object identification tags of each ball and receiving or accessing the respectively associated images, the augmented reality device 410 may, for example, superimpose each image over the respective ball, and as the juggler juggles the balls, the augmented reality display 426 of the augmented reality device 410 may cause the scene to appear to the viewer as though the juggler is juggling the three images. According to some embodiments, tracking the movement of the physical object can include visually identifying the physical object associated with the object identification tag, obtaining a video of the physical object by the augmented reality device 410 and applying video analysis techniques to the video of the physical object to trace the movements of the physical object. In some embodiments, augmented reality device 410 may utilize motion detection and tracking software to track the movement and position of the physical object within the field of view of the AR display 426 of the augmented reality device 410.

Additional processes may also be included. It should be understood that the process depicted in FIG. 6 represents an illustration and that other processes may be added or existing processes may be removed, modified, or rearranged without departing from the scope and spirit of the present disclosure.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

1. A computer-implemented method comprising:
storing, by an augmented reality device, user credentials;
detecting an object identification tag disposed on a physical object;
retrieving, from an online registry based on the user credentials and the object identification tag, virtual content associated with the physical object, wherein the virtual content comprises an interactive control panel associated with the physical object;
displaying, by the augmented reality device, the virtual content in association with the physical object;
receiving an input for the interactive control panel; and
causing an action to occur for the physical object based on the input for the interactive control panel.

2. The computer-implemented method of claim 1, wherein displaying the virtual content in association with the physical object comprises superimposing the virtual content over the physical object in an augmented reality display of the augmented reality device.

3. The computer-implemented method of claim 1, wherein the object identification tag disposed on the physical object comprises one of a barcode, a QR code, a radio frequency tag, or a wireless communication signal.

4. The computer-implemented method of claim 1, wherein the virtual content comprises at least one of an image, text, a video, an audio file or an interactive display.

5. The computer-implemented method of claim 1, further comprising:
tracking, by the augmented reality device, movement of the physical object; and
superimposing the virtual content over the physical object such that the virtual content moves to track the movement of the physical object.

6. The computer-implemented method of claim 5, wherein tracking the movement of the physical object comprises:
visually identifying the physical object associated with the object identification tag;
obtaining, by the augmented reality device, a video of the physical object; and
applying video analysis techniques to the video of the physical object to trace the movements of the physical object.

7. The computer-implemented method of claim 1, wherein retrieving the virtual content from the online registry comprises:
identifying a record in the registry that corresponds to the object identification tag; and
retrieving virtual content associated with the record in the registry.

8. The computer-implemented method of claim 7, wherein the online registry comprises a distributed ledger and the virtual content is stored in one or more blocks of the distributed ledger.

9. The computer-implemented method of claim 8, further comprising adding the virtual content to the online registry by a virtual content creator that is unaffiliated with a user of the augmented reality device.

10. The computer-implemented method of claim 1, wherein retrieving the virtual content comprises retrieving a first virtual content element that is accessible to all users and retrieving a second virtual content element that is accessible to authorized users, wherein the user credentials comprise security credentials that provide access to the second virtual content element.

11. A system comprising:
an augmented reality device having a processor communicatively coupled to a memory, the processor configured to:
store user credentials;
detect an object identification tag disposed on a physical object;
retrieve, from an online registry based on the user credentials and the object identification tag, virtual content associated with the physical object, wherein the virtual content comprises an interactive control panel associated with the physical object;
display, by an augmented reality display of the augmented reality device, the virtual content in association with the physical object;
receive an input for the interactive control panel; and
cause an action to occur for the physical object based on the input for the interactive control panel.

12. The system of claim 11, wherein displaying the virtual content in association with the physical object comprises superimposing the virtual content over the physical object in the augmented reality display of the augmented reality device.

13. The system of claim 11, wherein the object identification tag disposed on the physical object comprises one of a barcode, a QR code, a radio frequency tag, or a wireless communication signal.

14. The system of claim 11, wherein the virtual content comprises at least one of an image, text, a video, an audio file or an interactive display.

15. The system of claim 11, wherein the online registry comprises a distributed ledger and the virtual content is stored in one or more blocks of the distributed ledger.

16. The system of claim 11, wherein retrieving the virtual content comprises retrieving a first virtual content element that is accessible to all users and retrieving a second virtual content element that is accessible to authorized users, wherein the user credentials comprises security credentials that provide access to the second virtual content element.

17. A computer program product comprising a computer readable storage medium having program instructions embodied therewith the program instructions executable by a computer processor to cause the computer processor to perform a method comprising:
storing, by an augmented reality device, user credentials;
detecting an object identification tag disposed on a physical object;
retrieving, from an online registry based on the user credentials and the object identification tag, virtual content associated with the physical object, wherein the virtual content comprises an interactive control panel associated with the physical object;
displaying, by the augmented reality device, the virtual content in association with the physical object;
receiving an input for the interactive control panel; and causing an action to occur for the physical object based on the input for the interactive control panel.

18. The computer program product of claim 17, wherein displaying the virtual content in association with the physical object comprises superimposing the virtual content over the physical object in an augmented reality display of the augmented reality device.

19. The computer program product of claim 17, wherein the object identification tag disposed on the physical object comprises one of a barcode, a QR code, a radio frequency tag, or a wireless communication signal.

20. The computer program product of claim 17, wherein the virtual content comprises at least one of an image, a video, an audio file or an interactive display.
